(19) United States
(12) Patent Application Publication
(10) Pub. No.: US 2014/0067712 A1
(43) Pub. Date: Mar. 6, 2014

(54) Financial Goal Management

(71) Applicants: Alok Prasad, Ridgewood, NJ (US); Kabir Sethi, New York, NY (US); James Masco, Jackson, NJ (US); Forrest David Skriletz, Jersey City, NJ (US); Michael F. Nannini, III, Jackson, NJ (US); Richard Steinmeier, Lawrenceville, NJ (US)

(72) Inventors: Alok Prasad, Ridgewood, NJ (US); Kabir Sethi, New York, NY (US); James Masco, Jackson, NJ (US); Forrest David Skriletz, Jersey City, NJ (US); Michael F. Nannini, III, Jackson, NJ (US); Richard Steinmeier, Lawrenceville, NJ (US)

(73) Assignee: BANK OF AMERICA, Charlotte, NC (US)

(21) Appl. No.: 13/599,767

(22) Filed: Aug. 30, 2012

(51) Int. Cl. G06Q 40/06

(52) U.S. Cl. 705/36 R

(57) ABSTRACT

A financial goal management system for managing client financial goals is provided. The financial goal management system receives financial goal information indicative of a financial goal and account information indicative of an account associated with the financial goal. The financial goal management system determines savings recommendation information indicative of a recommended savings value based on the financial goal information and the account information. Subsequently, the financial goal management system determines progress-to-goal information based on the financial goal information, the account information, and the savings recommendation information. In some arrangements, the financial goal management system may further determine action step information indicative of action steps to be performed while progressing towards completion of the financial goal.

### BACKGROUND

Clients such as financial services customers have become increasingly task oriented and, as a result, may desire specific objectives with respect to their finances. One solution has been to identify and capture customer needs in view of their financial goals. However, these customer needs are typically addressed across several different organizations and representatives. As a result, customer experience may be negatively impacted by navigating through an unduly complex and burdensome system in order to address their financial goals.

### SUMMARY

In accordance with various aspects of the disclosure, systems and methods are provided for identifying and managing a client's financial goals. A financial goal may correspond to a desired future value of a particular account at the end of a pre-determined timeframe. In some aspects, a financial goal management system may uniquely capture and analyze a client's financial goals and generate customized and/or targeted action plans to assist the client in achieving their financial goals. In some embodiments, aspects of the disclosure may be provided in a computer-readable storage medium having computer-executable instructions that, when executed by one or more processors, perform one or more of the process steps described herein. The computer-readable storage medium may be non-transitory.

According to an aspect of the disclosure, a financial goal management system may receive financial goal information indicative of a client's financial goal and account information indicative of an account (e.g., savings account, investment account) associated with the financial goal. The financial goal information may include a financial goal type, a financial goal value, and a financial goal timeframe. The financial goal type may be, for example, a type of savings or investment fund such as a retirement fund, an education fund, an emergency fund, a large purchase fund, and a general accumulation fund. The financial goal value may be, for example, a desired future monetary value of a savings or investment account at a target date indicated by the financial goal timeframe. The financial goal timeframe may be indicative of, for example, a target date (e.g., in the future) or the number of days, months, or years before the target date is reached. The account information may include an account value, such as the current or present monetary value of the particular account associated with the financial goal. In some instances, the financial goal management system may link the financial goal indicated by the financial goal information to the account indicated by the account information. In some instances, the financial goal management system may establish the account indicated by the account information.

In some aspects, the financial goal management system may determine action step information and savings recommendation information based on the financial information and the account information. The action step information may be indicative of one or more action steps associated with the financial goal. Each of the one or more action steps may be associated with an action step status, such as completed, in process, and not started. The savings recommendation information may include, for example, a recommended savings value for each of a plurality of remaining periods of the financial goal timeframe. For example, the recommended savings value may be a recommended monetary value to be saved each month to achieve the financial goal value on or before the target date indicated by the financial goal timeframe.

In some aspects, the financial goal management system may determine progress-to-goal information based on the financial information, the account information, the action step information, and the savings recommendation information. The progress-to-goal information may include, for example, a progress-to-goal percentage value determined by, for example, dividing the account value by the financial goal value.

In some aspects, the financial goal management system may generate and transmit a report based on the financial goal information, the account information, the action step information, and the progress-to-goal information. For example, the financial goal management system may generate a progress-to-goal report indicative of the client's progress towards each of their financial goals. In another example, the financial goal management system may generate an activity record by mapping the financial goal to the account associated with the financial goal. Subsequently, the financial goal management system may transmit the report to the client using paper or electronic delivery techniques.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented in accordance with example embodiments.

FIG. 2 illustrates an example computing environment for providing financial goal management in accordance with example embodiments.

FIG. 3 illustrates an example system for providing financial goal management in accordance with example embodiments.

FIG. 4 illustrates an example user interface for providing financial goal management in accordance with example embodiments.

FIG. 5 illustrates another example user interface for providing financial goal management in accordance with example embodiments.

FIG. 6 illustrates another example user interface for providing financial goal management in accordance with example embodiments.

FIG. 7 illustrates an example progress-to-goal report in accordance with example embodiments.

FIG. 8 illustrates an example process flow for providing financial goal management in accordance with example embodiments.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the claimed subject matter.

A financial goal management system may provide identification, assessment, management, monitoring, and reporting of information associated with one or more financial goals associated with a client. The financial goal management system may provide one or more user interfaces which financial advisors (e.g., human users) may use during financial goal and other investment consultations with clients. The financial goal management system may be linked to general investment processes and systems. The financial goal management system may capture and prioritize a client's financial goals, determine action steps to achieve the client's goals, link one or more accounts to the client's financial goals, calculate a recommended monthly savings amount for achieving the client's financial goals, and generate and deliver progress-to-goal reports indicative of the client's progress towards each of their financial goals. In some arrangements, the financial goal management system may also generate periodic (e.g., semi-annual) reports to measure the client's progress against the client's financial goals. Each periodic report may provide a customized view of the client's financial situation with completed action steps to achieve the client's financial goals.

In an illustrative example, a client may tell a financial advisor that they want to set up an emergency fund for any type of emergency that may occur in the client's household. The financial advisor may use the financial goal management system to establish an emergency fund goal for the client, link it to a particular savings or investment account, and capture the client's desired timeframe for the emergency fund goal and the level of risk the client is willing to take related to the investments in that account. The financial goal management system may then generate a calculated monthly savings amount for meeting that goal within the client's timeframe and show the financial advisor the client's progress towards achieving the emergency fund goal (e.g., by displaying a progress bar indicating that the client is X % of the way to meeting the emergency fund goal). The financial goal management system may also generate a progress-to-goal report, which the client may receive on a semi-annual basis. The progress-to-goal report may show the client their progress based on the account they have linked to the emergency fund goal, the action steps that have been completed, and the action steps that are recommended to be completed to progress towards completion of the emergency fund goal.

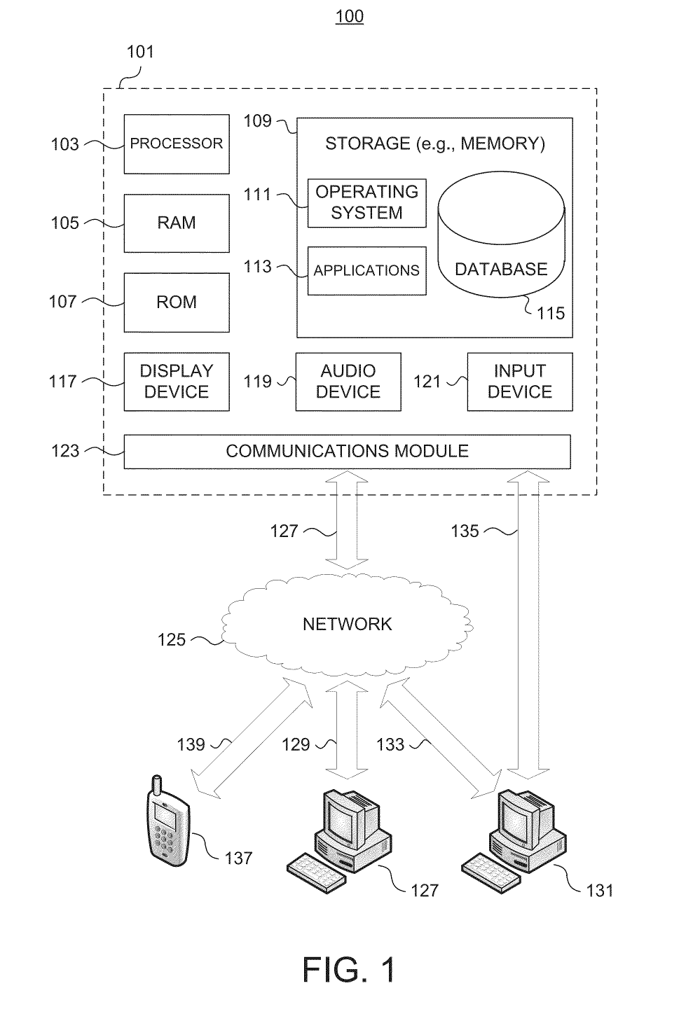

FIG. 1 illustrates an example of a computing system 100 in which one or more aspects described herein may be implemented in accordance with example embodiments. Computing system 100 is only one example of a computing environment and is not intended to suggest any limitation as to the scope of use or functionality of the disclosure. The disclosure is operational with numerous other general purpose or special purpose computing environments or configurations, such as personal computers, server computers, hand-held or laptop devices, tablet computers, multiprocessor systems, microprocessor-based systems, set top boxes, programmable consumer electronics, network PCs, minicomputers, mainframe computers, distributed computing environments, and other computing systems and combinations of computing systems.

Computing system 100 may include computing device 101 wherein the processes discussed herein may be implemented. Computing device 101 may include a variety of components for inputting, outputting, storing and processing information and other data. For example, computing device 101 may include processor 103 for executing one or more applications, retrieving data from a storage device, outputting data to a device, or performing any other process. Processor 103 may be communicatively coupled to Random Access Memory (RAM) 105 in which application data, instructions, or other computer-readable media may be temporarily stored and accessed. Computing device 101 may further include Read Only Memory (ROM) 107 which allows data and computer-readable media stored thereon to persist after computing device 101 has been turned off. ROM 107 may be used for a variety of purposes including storage of a Basic Input/Output System (BIOS) for computing device 101. ROM 107 may further store date and time information so that the information persists through power losses, shut downs, and reboots.

In some embodiments, computing device 101 may include storage 109. For example, storage 109 may provide long term storage for a variety of data including operating system 111, applications 113, and database 115. Storage 109 may include any of a variety of computer readable media such as disc drives, optical storage mediums, magnetic tape storage systems, flash memory and other storage devices. In one example, processor 103 may retrieve an application from applications 113 in storage 109 and temporarily store the instructions associated with the application in RAM module 105 while the application is executing. In another example, some or all of the computer executable instructions for computing device 101 may be embodied in hardware or firmware, which is not shown to avoid overcomplicating the drawing. In certain embodiments, applications 113 may include computer executable instructions for performing financial goal management. In certain embodiments, applications 113 may include computer executable instructions for invoking user functionality related to communication including email, short message service (SMS), and voice input and speech recognition applications. In certain embodiments, database 121 may provide centralized storage of information including attributes about clients and their financial goals, characteristics about different accounts and account types, and other information that may be received from different points in system 100, such as computing devices 101, 127, 131, 137, or any other device or combination of devices.

In some embodiments, computing device 101 may include display device 117 for displaying textual, audiovisual, graphical information, or any other information, such as a graphical user interface (GUI). Display device 117 may be, for example, an internal or external monitor, television, or touch screen display that receives display data from, for example, processor 103. In certain implementations, computing device 101 may include one or more output device controllers, such as a video processor, for translating processor instructions into corresponding video signals for display by display device 117.

In some embodiments, computing device 101 may include audio device 119, such as a speaker, for outputting audio data and notifications provided by processor 103 or any other device. In certain implementations, computing device 101 may include one or more output device controllers, such as an audio processor, for translating processor instructions into corresponding audio signals to be sounded by audio device 119.

In some embodiments, computing device 101 may include input device 121 for receiving input directly or indirectly from a user. Input device 121 may include, for example, a keyboard, a microphone, a touch screen display, a storage media drive, an optical scanning device, or any other device for receiving user input. In certain implementations, computing device 101 may include one or more input device controllers for translating input data into computer readable or recognizable data. For example, voice input received from a microphone may be converted into a digital format and stored in a data file in RAM 105, ROM 107, storage 109, or any other storage device. In another example, tactile input received from a touch screen interface may be converted into a digital format and stored in a data file. In another example, a physical file (e.g., paper documents, correspondence, receipts, and the like) may be scanned and converted into a digital file by an optical scanner and received as input. In certain implementations, a device such as a media drive (e.g., DVD-R, CD-RW, external hard drive, flash memory drive, and the like) may act as both an input and output device allowing a user to both write and read data to and from computing device 101.

In some embodiments, computing device 101 may include one or more communication components for receiving and transmitting data over a network. For example, computing device 101 may include communications module 123 for communicating with network 125 over communications path 127. Network 125 may include, for example, an Internet Protocol (IP) network, a wide-area network (WAN), a local-area network (LAN), a local wireless network (e.g., WiMAX), a digital broadcast network, a digital subscriber line (DSL) network, a frame relay network, an asynchronous transfer mode (ATM) network, a virtual private network (VPN), a cellular network, a telephone network, a fiber optic network, a satellite network, and any other network or combination of networks. Communications path 127 may include any wired or wireless communications path, such as a wide area network (WAN) path, a local area network (LAN) path, a cellular communications path, or any other path. Communications module 123 may include the corresponding circuitry for communicating with network 125 and with other devices on the network. For example, communications module 123 may include a wired interface, wireless interface, or a combination of the two. In an illustrative example, communications module 123 may facilitate transmission of data such as electronic mail messages, financial data, or both over an organization's network. In another example, communications module 123 may facilitate transmission or receipt of information over the Internet. In some embodiments, communications module 123 may include one or more sets of instructions relating to one or more networking protocols. For example, communications module 123 may include a first set of instructions for processing IP network packets and a second set of instructions for processing cellular network packets.

In some embodiments, computing device 101 may operate in a networked environment supporting connections to one or more remote computing devices. For example, computing system 100 may include computing device 127 communicatively coupled to network 125 through communications path 129 (e.g., a WAN communications path), computing device 131 communicatively coupled to network 125 through communications path 133 (e.g., a WAN communications path), and computing device 137 communicatively coupled to network 125 through communications path 139 (e.g., a cellular carrier or WAN communications path). In certain implementations, computing device 131 may be directly communicatively coupled to communications module 123 in computing device 101 through communications path 135 (e.g., a LAN communications path). Computing devices 127 and 131 may be, for example, personal computing devices or servers and may include any of the elements described above with reference to computing device 101. Computing device 137 may be, for example, a portable computing device, such as a mobile communications device or tablet computer, and may include any of the elements described above with reference to computing device 101. Communications paths 129, 133, 135, and 139 may be any communications path or paths, such as those described with reference to communications path 127.

It will be appreciated that the network connections shown are illustrative and other means of establishing a communications link between the computing devices may be used. The existence of any of various well-known protocols such as Transmission Control Protocol/Internet Protocol (TCP/IP), Ethernet, File Transfer Protocol (FTP), Hypertext Transfer Protocol (HTTP), Data Over Cable Service Interface Specification (DOCSIS) and the like is presumed, and the system can be operated in a client-server configuration to permit a user to retrieve web pages from a web-based server. Any of various conventional web browsers can be used to display, input, and manipulate data on web pages. The network connections may also provide connectivity to a closed-circuit television (CCTV) or an image capturing device, such as an iris or face recognition device.

Although not required, various aspects described herein may be embodied as a method, a data processing system, or a computer-readable medium storing computer-executable instructions. In some embodiments, a computer-readable medium storing instructions to cause a processor to perform steps of a method in accordance with aspects of the disclosure is contemplated. Aspects of the method steps disclosed herein may be executed on, for example, processor 103 in computing device 101. For example, processor 103 may execute computer-executable instructions stored on a computer-readable medium, such as RAM 105, ROM 107, storage 109, or any other device or combination of devices.

One of skill in the art will appreciate that computing systems such as computing system 100 may include a variety of other components and are not limited to the devices and configurations described in FIG. 1.

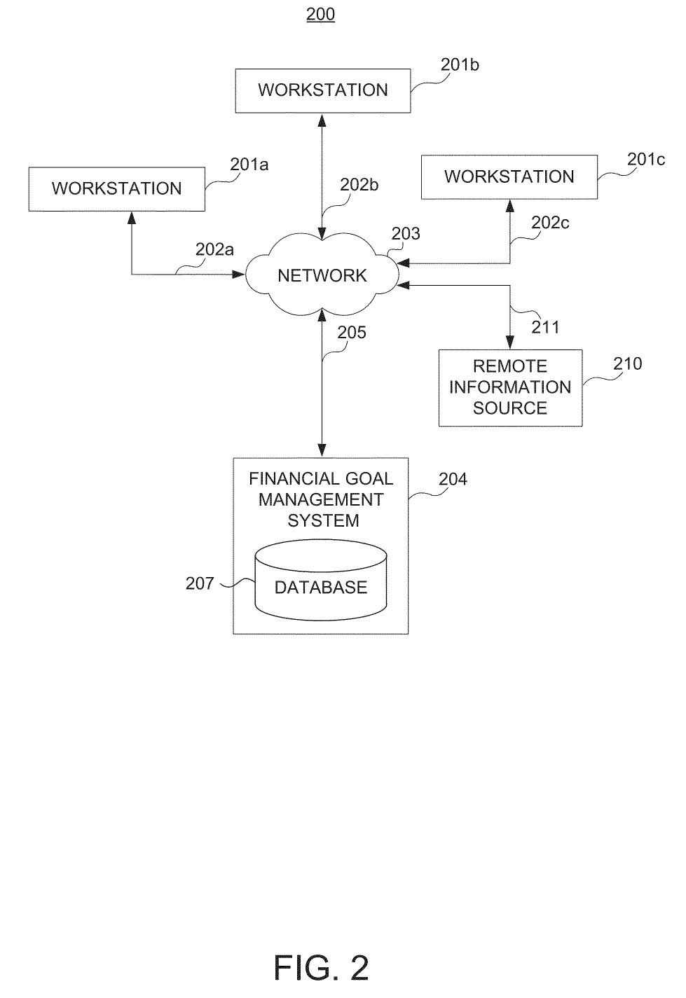

FIG. 2 illustrates an example computing system 200 for providing financial goal management in accordance with example embodiments. As illustrated, system 200 may include one or more workstations 201 (e.g., workstations 201a, 201b, 201c), which may be any computing device or devices, such as those described with reference to computing devices 101, 127, 131, and 137. Workstations 201 may be local or remote, and may be communicatively coupled by one or more communications paths 202 (e.g., 202a, 202b, 202c) to network 203. Network 203 may any communications network, such as network 125, and may be communicatively coupled to financial goal management system 204 via communications path 205. Communications paths 202 and 205 may include any communications path or paths, such as those described with reference to communications path 127.

Financial goal management system 204 may be a data processing device (e.g., computing device 101) for managing financial goals. Financial goal management system 204 may include, or be communicatively coupled to, database 207 to receive, store, process, and output information. Database 207 may include, for example, any combination of features described with reference to RAM 105, ROM 107, and storage 109. Financial goal management system 204, database 207, or both may be configured to offer any desired service and may run or support various computing languages and operating systems, such as Structured Query Language (SQL), Java Persistence Query Language (JPQL), Active Server Pages (ASP), Hypertext Preprocessor (PHP), JavaServer Pages (JSP), Microsoft Windows, Macintosh OS, Apache Tomcat, Unix, Berkeley Software Distribution (BSD), Ubuntu, Redhat Linux, Hypertext Markup Language (HTML), JavaScript, Asynchronous JavaScript and XML (AJAX), Comet, and other languages, operating systems, and combinations thereof. Other types of database languages and structures may be used as desired.

In some embodiments, system 200 may include remote information source 210, which may be communicatively coupled to financial goal management system 204, workstations 201, or both through network 203. Remote information source 210 may be a computing device (e.g., computing device 101) for receiving, determining, and/or providing any of the information described herein. For example, remote information source 210 may be a server, database, or both that includes information about or information maintained by a third-party, such as a wealth management company. Remote information source 210 may be communicatively coupled to network 203 through communications path 211, which may include any communications path or paths, such as those described with reference to communications path 127.

In some embodiments, users of workstations 201 may access financial goal management system 204 to request and retrieve information from financial goal management system 204, database 207, and/or remote information source 210. For example, users of workstations 201 may access information associated with a specific financial goal which they are responsible for managing and input and/or request financial goal information, such as values and textual comments for the financial goal, and account information, such as values and textual comments for the account or accounts associated with the financial goal. Workstations 201 may transmit the information to financial goal management system 204 over network 203. Financial goal management system 204 may process the received financial goal information and account information to manage the financial goal, such as by determining savings recommendation information, action step information, and progress-to-goal information.

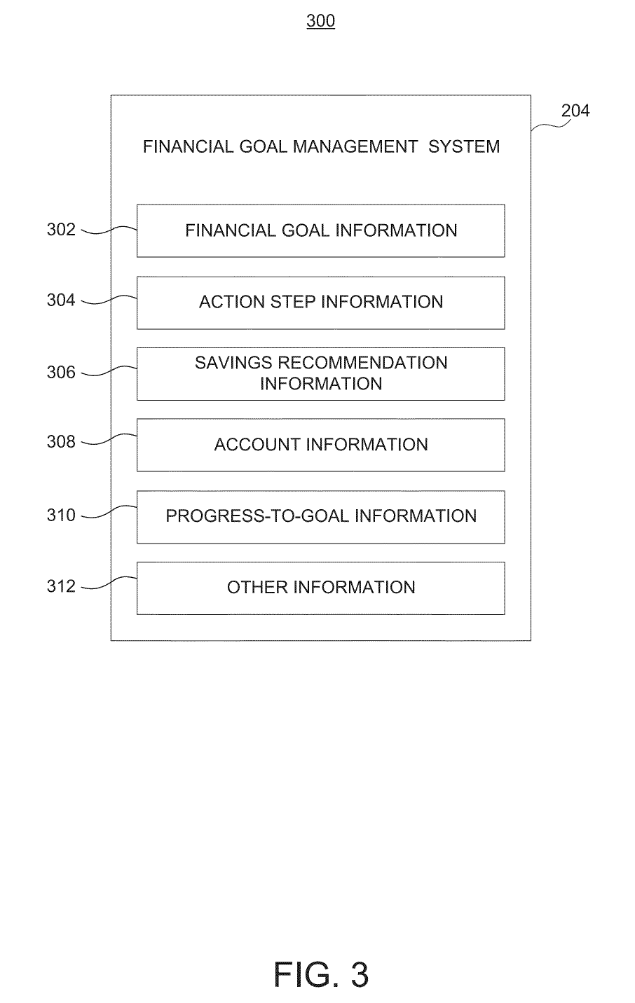

FIG. 3 illustrates an example system 300 for providing financial goal management using financial goal management system 204 in accordance with example embodiments. Financial goal management system 204 may include a processing device (e.g., processor 103) for processing information and a storage device (e.g., database 207) for storing information. Financial goal management system 204 may include or have access to, for example, financial goal information 302, action step information 304, savings recommendation information 306, account information 308, progress-to-goal information 310, and other information 312.

Financial goal management system 204 may receive financial goal information 302 in response to user input, such as input from a client or a financial advisor using input device 121. Financial goal information 302 may include, for example, information indicative of one or more financial goals to be managed by financial goal management system 204. For example, financial goal information 302 may include client information and information indicative of a financial goal type, a financial goal timeframe, a financial goal value, a risk tolerance value, an assumed future rate of return value, and a financial goal priority value for each of one or more financial goals. In some instances, financial goal management system 204 may prioritize a plurality of financial goals based on their respective financial goal priority values.

Client information may include, for example, identification information (e.g., name, address, identification number) and information indicative of a client's income, savings, assets, accounts, risk profile, preferences, and any other information. In some instances, client information may include information for two or more clients, such as a client and the client's spouse, relative, or business partner.

The financial goal type may be, for example, a type of savings or investment fund associated with the financial goal, such as a retirement fund, an education fund, an emergency fund, a large purchase fund, and a general accumulation fund. In some arrangements, the financial goal type may correspond to other types of goals, such as wealth transfer goals, budget management goals, and liabilities.

The financial goal timeframe may be indicative of, for example, a future target date or the number of days, months, or years before the target date is reached. For example, the financial goal timeframe may be indicative of a target year TY.

The financial goal value may be, for example, a future monetary value, such as the desired future value FV of the savings or investment account associated with the financial goal on the target date indicated by the financial goal timeframe.

The risk tolerance value may be indicative of, for example, the client's overall risk tolerance level or the client's risk tolerance level towards a particular financial goal. For example, the risk tolerance value may be one of aggressive, moderately aggressive, moderate, moderately conservative, and conservative. In some instances, the risk tolerance value for one financial goal may be different from the risk tolerance value for another financial goal. For example, the risk tolerance value for an education goal may be moderately conservative, and the risk tolerance value for a large purchase goal may be moderately aggressive.

The assumed future rate of return (AFROR) value may be indicative of, for example, an estimation of the future rate of return (e.g., the ratio of monetary gain or loss relative to the monetary value invested) of the account associated with (or to be associated with) the financial goal. For example, the AFROR value may be an estimated annual rate of return, such as 6.50%.

The financial goal priority value may be indicative of, for example, the priority of a financial goal among two or more financial goals. In some arrangements, financial goal management system 204 may prioritize a plurality of financial goals based on their respective financial goal priority values. For example, a client may have an education goal with a financial goal priority value of 1 and a retirement goal with a financial goal priority value of 2. As a result, financial goal management system 204 may determine that the education goal is a higher priority than the retirement level, and determine savings recommendation information accordingly (e.g., by determining a higher recommended monthly savings value for the education goal and a lower recommended monthly savings value for the retirement goal).

Financial goal management system 204 may determine action step information 304 based on financial goal information 302. Action step information 304 may include, for example, information indicative of one or more action steps (e.g., action items) associated with the financial goal. For example, action steps for a financial goal may include performing a financial goal analysis with the client, identifying the type and amount of savings for achieving the financial goal, establishing a savings or investment account for the financial goal, and tracking the client's progress towards achieving the financial goal. In some instances, each of the action steps may be associated with an action step status, such as completed, in process, or not started.

Financial goal management system 204 may determine savings recommendation information 306 based on financial goal information 302. Savings recommendation information 306 may include, for example, a recommended savings value RSV for each of a plurality of remaining periods until the end of the financial goal timeframe. For example, the recommended savings value may be a recommended monetary value to be saved each month or year to achieve the financial goal value by the target date indicated by the financial goal timeframe.

In some arrangements, financial goal management system 204 may determine a recommended monthly savings value RSVₘ as shown in Equation 1:

$${RSV}_{m} = \frac{{r}_{m} * [ PV * {( 1 + {r}_{m} )}^{N} - FV ]}{( 1 + {r}_{m} ) * [ {( 1 + {r}_{m} )}^{N} - 1 ]} \qquad ( 1 )$$

where PV is the present value of the account (e.g., the account value), FV is the future value of the account (e.g., the financial goal value), N is the number of months remaining until the end of the financial goal timeframe, and rₘ is the assumed monthly rate of return. The number of remaining months N may be determined as shown in Equation 2:

N=(TY−PY−1)*12+12−PM (2)

where TY is the target year of the financial goal timeframe, PY is the present year, and PM is the present month. The assumed monthly rate of return value rₘ may be determined as shown in Equation 3:

rₘ=[1+AFROR]^{1/12}−1 (3)

where AFROR is assumed future rate of return value associated with the financial goal.

Account information 308 may include, for example, information indicative of one or more accounts associated with a financial goal. For example, account information 308 may include account identification information and information indicative of an account type and an account value. The account identification information may include, for example, an account number, such as a nine-digit account number XXXXXXXXX. The account type may be indicative of the particular type (e.g., savings, investment) account associated with the financial goal. The account value may be, for example, a current or present monetary value of the particular account associated with the financial goal, such as the present value PV of the account. In some instances, financial goal management system 204 may establish or otherwise open the account. In some instances, financial goal management system 204 may link the financial goal indicated by the financial goal information to the account indicated by the account information.

In some arrangements, financial goal management system 204 may determine the account type based on the financial goal information. In one example, financial goal management system 204 may determine that the account type may be a savings account with an assumed future rate of return of 2.1% based on a conservative risk tolerance value. In another example, financial goal management system 204 may determine that the account type may be an investment account with an assumed future rate of return of 11.5% based on an aggressive risk tolerance value.

Financial goal management system 204 may determine progress-to-goal information 310 based on financial goal information 302, action step information 304, savings recommendation information 306, and account information 308. Progress-to-goal information 310 may include, for example, a progress-to goal percentage value indicative of the progress the client has made towards achieving the financial goal. Financial goal management system 204 may determine the progress-to-goal percentage value PTG by, for example, dividing the account value PV by the financial goal value FV as shown in Equation 4:

$$PTG = \frac{PV}{FV} \qquad ( 4 )$$

In an illustrative example, a client may call a financial advisor about establishing an education fund for one of the client's children. As part of client profiling, the financial advisor may capture key information about the client and input the information into financial goal management system 204 using an input device such as input device 121. The captured information may include, for example, the client's income, the client's current savings, the client's assets are and how they are invested, the client's risk profile, and the client's priorities with regard to their financial goals. Financial goal management system 204 may receive the information, determine an action step to set up an education fund, and prioritize the education goal as a first priority. Financial goal management system 204 may then capture additional information related to the client and the client's financial goal, such as additional action steps. One of the action steps may be, for example, to complete an education analysis with the client to identify the type of savings and timeframe for achieving the education goal. For example, if the client's goal is to have an education fund with an account value of $100,000 in 10 years, financial goal management system 204 may determine a recommended savings value of $586 per month based on an assumed future rate of return of 6.85% (e.g., based on a moderately aggressive risk tolerance value). Subsequently, financial goal management system 204 may update the action item status to reflect that the educational analysis has been completed and that the recommended savings value has been identified. Financial goal management system 204 may then send an educational analysis document showing how the recommended savings value was determined.

Once the client, the financial advisor, or financial goal management system 204 has opened and funded the account, the progress-to-goal reporting described herein is initiated. Financial goal management system 204 may generate a progress-to-goal report at periodic time intervals (e.g., every 6 months) for each financial goal and transmit the progress-to-goal report to the client. Financial goal management system 204 may also request updated account information (e.g., changes in account balances), updated assumed rates of return, and updated client information, such as whether there are any changes in the client's life, allocation or investment strategies. For example, the client may want to set up an automated monthly investment plan for the account associated with the financial goal. In another example, the client may have a new financial goal, such as a second education goal due to the birth of a child. In another example, the client's income level may have changed (e.g., the client's spouse may no longer work).

Financial goal management system 204 may perform these periodic assessments more or less frequently in response to input from the client or the financial advisor. For example, information stored in financial goal management system 204 may be updated by a financial advisor based on their periodic conversations with their client that may identify new financial goals, updates to action steps, and/or removal of financial goals. For example, if a financial goal is no longer is a priority, financial goal management system 204 may deprioritize or cancel that particular financial goal for that client.

In some embodiments, financial goal management system 204 may determine an actual rate of return value associated with the account. Financial goal management system 204 may then determine whether the actual rate of return value is different from the assumed future rate of return value. If the actual rate of return value is different from the assumed future rate of return value, financial goal management system 204 may determine an updated recommended savings value (e.g., by increasing or decreasing the recommended savings value), an updated assumed future rate of return value (e.g., by increasing or decreasing the risk tolerance value), or both. For example, if the assumed future rate of return value is greater than the actual rate of return value, financial goal management system 204 may determine an updated recommended savings value based on an updated assumed future rate of return (e.g., which may be equal to or based on the actual rate of return value). In this case, the updated recommended savings value may be greater than the previously determined recommended savings value. In another example, if the assumed future rate of return value is less than the actual rate of return value, financial goal management system 204 may determine an updated recommended savings value that is less than the previously determined recommended savings value. In some instances, financial goal management system 204 may change the account type of the account to reflect an updated risk tolerance value (e.g., which may be provided by the client) and an updated assumed future rate of return. As a result, financial goal management system 204 may allow the difference between the previous recommended savings value and the updated recommended savings value to remain less than a threshold value (e.g., 10%, $100 per month).

In some embodiments, financial goal management system 204 may generate and transmit a report based on financial goal information 302, action step information 304, savings recommendation information 306, account information 308, progress-to-goal information 310, and other information 312. For example, financial goal management system 204 may generate a progress-to-goal report based on progress-to-goal information 310. In another example, financial goal management system 204 may generate an activity record by mapping financial goal information 302 to account information 308 (e.g., by mapping the financial goal to the account associated with the financial goal). Subsequently, financial goal management system 204 may transmit the report to a computing device such as a printing device (e.g., to print a copy of the report for mailing to the client), a facsimile device (e.g., for faxing the report to the client), a personal computer (e.g., for emailing the report to the client), a wireless device such as a mobile phone or tablet computer (e.g., for emailing or instant messaging the report to the client), a database or other storage device (e.g., for storing the report), or any other device. In some instances, financial goal management system 204 may transmit the activity record to a computing device, such as a server or a storage device, for memorializing (e.g., storing) client conversations and activities.

Other information 312 may include any other types of financial, account, client, company or organization information received or generated by financial goal management system 204. For example, other information may include information such as wealth management information, contractual information, market information, legal and regulatory information, scheduling information, employee data, and miscellaneous client data.

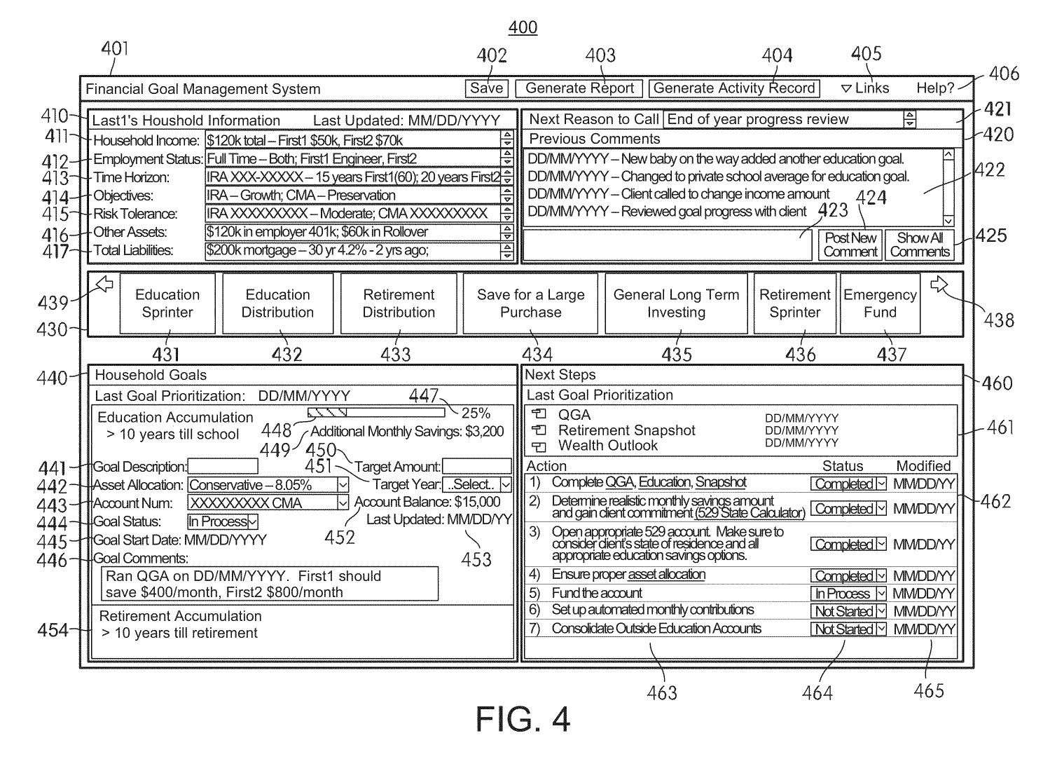

FIGS. 4-6 show illustrative user interfaces for displaying information and receiving input from users in accordance with various aspects of the disclosure. The illustrative user interfaces of FIGS. 4-6 may be implemented by one or more of the components discussed with reference to FIGS. 1-2 or any other component or combination of components. It will be appreciated that any feature discussed with reference to one of the user interfaces shown in FIGS. 4-6 may be partially or wholly implemented in any other user interface described herein.

FIG. 4 illustrates an example user interface 400 for providing financial goal management in accordance with example embodiments. User interface 400 may be displayed on workstation 201 using, for example, display device 117. User interface 400 may include, for example, display screen 401 for displaying multiple selectable fields and icons by which a financial advisor may input or access information using an input device.

User interface 400 may include client information region 410 for viewing and editing (e.g., updating) client profile information. Client information region 410 may include, for example, selectable fields such as household income field 411, employment status field 412, time horizon field 413, financial objectives field 414, risk tolerance field 415, other assets field 416, and total liabilities field 417.

User interface 400 may include financial advisor information region 420 for inputting and viewing free form comments and a next reason to contact (e.g., call, mail, email, instant message) the client. Financial advisor information region 420 may include, for example, selectable fields such as field 421 indicative of the next reason for the financial advisor to contact the client, previous comments field 422, and comment field 423. The financial advisor may input a text comment in field 423 and save the comment by selecting icon 424 (e.g., Post New Comment). The financial advisor may view all comments by selecting icon 425 (e.g., Show All Comments).

User interface 400 may include financial goal region 430 for allowing the financial advisor to drag and drop financial goal capabilities (e.g., into client financial goal region 440). For example, financial goal region 430 may include selectable financial goal icons 431, 432, 433, 434, 435, 436, and 437 by which the financial advisor may view or establish a client's financial goals. The financial advisor may navigate through the financial goal icons by selecting right arrow icon 438 or left arrow icon 439.

User interface 400 may include client financial goal region 440 for capturing (e.g., inputting) and prioritizing a client's financial goals. Client financial goal region 440 may include, for example, selectable fields such as goal description field 441, asset allocation field 442, account number field 443, goal status field 444 (e.g., “in process”), goal start date field 445, goal comments field 446, progress-to-goal percentage value field 447, progress-to-goal bar 448, recommended savings value field 449, target amount field 450, target year field 451, account balance field 452, and last update field 453. Client financial goal region 440 may also include selectable icons for displaying information associated with the client's other financial goals, such as other financial goal region 454.

User interface 400 may include client action step region 460 for viewing and editing (e.g., updating) action steps associated with the client's financial goals. Client action step region 460 may include, for example, selectable regions such as last generated reports region 461 (e.g., for accessing completed financial reports) and action step region 462 (e.g., for tracking progress toward action steps). Action step region 462 may include action step fields 463 indicative of actions steps associated with the client's financial goal, action step status fields 464, and action step modification date fields 465.

User interface 400 may include selectable icons such as save icon 402 for saving the information included in user interface 400, generate report icon 403 for generating and previewing a progress-to-goal report based on the information included in user interface 400, and generate activity record icon 404 for generating an activity record (e.g., a real-time activity note). User interface 400 may also include links icon 405 for accessing other information or tools, such as wealth management tools and resources, and help icon 406 for accessing help and troubleshooting information related to user interface 400.

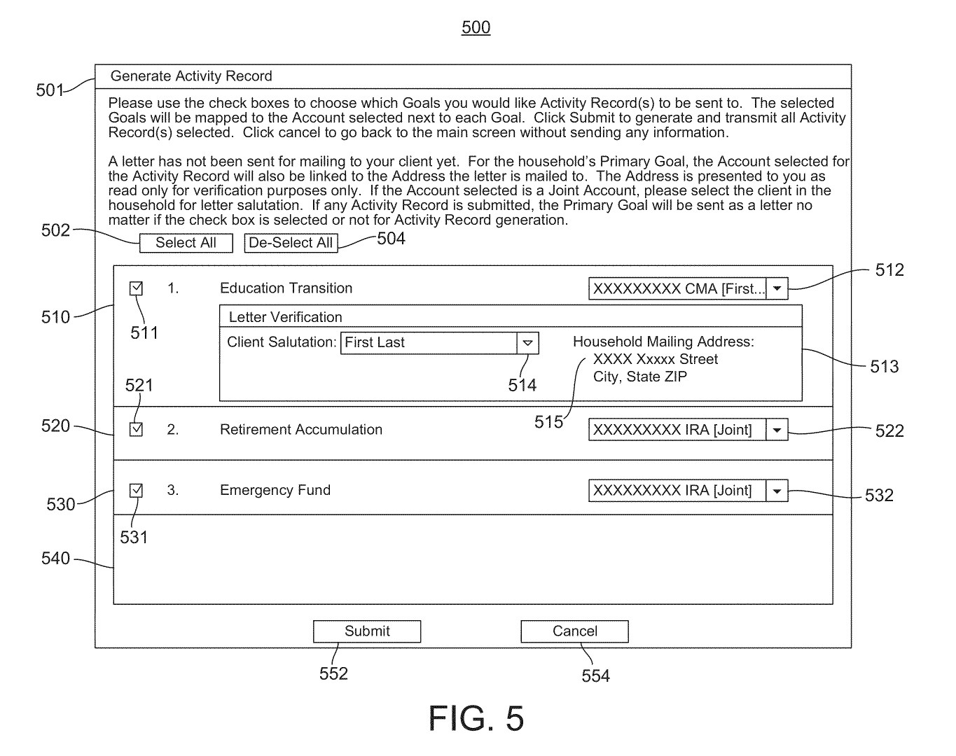

FIG. 5 illustrates an example user interface 500 generating an activity record based on the information included in user interface 400 in accordance with example embodiments. For example, user interface 500 may appear as a display screen overlay in response to a user selecting generate activity record icon 404. User interface 500 may include, for example, display screen 501 for displaying multiple selectable fields and icons by which a financial advisor may input or access information using an input device.

User interface 500 may include client financial goal regions 510, 520, 530, and 540 for generating one or more activity reports for a client's financial goals. Client financial goal region 510 may include, for example, a selectable check box 511 for indicating whether to generate an activity record for a first financial goal (e.g., “1. Education Transition”) associated with the account in account identification field 512. Client financial goal region 510 may also include letter verification region 513, which may include client information to be included in the activity record, such as client salutation field 514 (e.g., “First Last”) and client household mailing address field 515. Client financial goal region 520 may include, for example, a selectable check box 521 for indicating whether to generate an activity record for a second financial goal (e.g., “2. Retirement Accumulation”) associated with the account in account identification field 522. Client financial goal region 530 may include, for example, a selectable check box 531 for indicating whether to generate an activity record for a third financial goal (e.g., “3. Emergency Fund”) associated with the account in account identification field 532. Client financial goal region 540 may include, for example, information for any number of additional financial goals or other information, such as information included in user interface 400. In certain implementations, user interface 500 may include selectable icons such as select all icon 502 for selecting (e.g., checking) all of check boxes 511, 521, and 531 and de-select all icon 504 for de-selecting (e.g., unchecking) all of check boxes 511, 521, and 531.

User interface 500 may include submit icon 552 for generating activity records for the selected financial goals and cancel icon 554 for canceling user interface 500. For example, the generation of an activity record may be initiated or triggered when submit icon 552 is selected. Financial goal management system 204 may then generate the activity report or reports by mapping the financial goal to the account associated with the financial goal. When cancel icon 554 is selected, the information included in user interface 500 may not be saved, display screen 501 may disappear, and, in some instances, display screen 401 may appear.

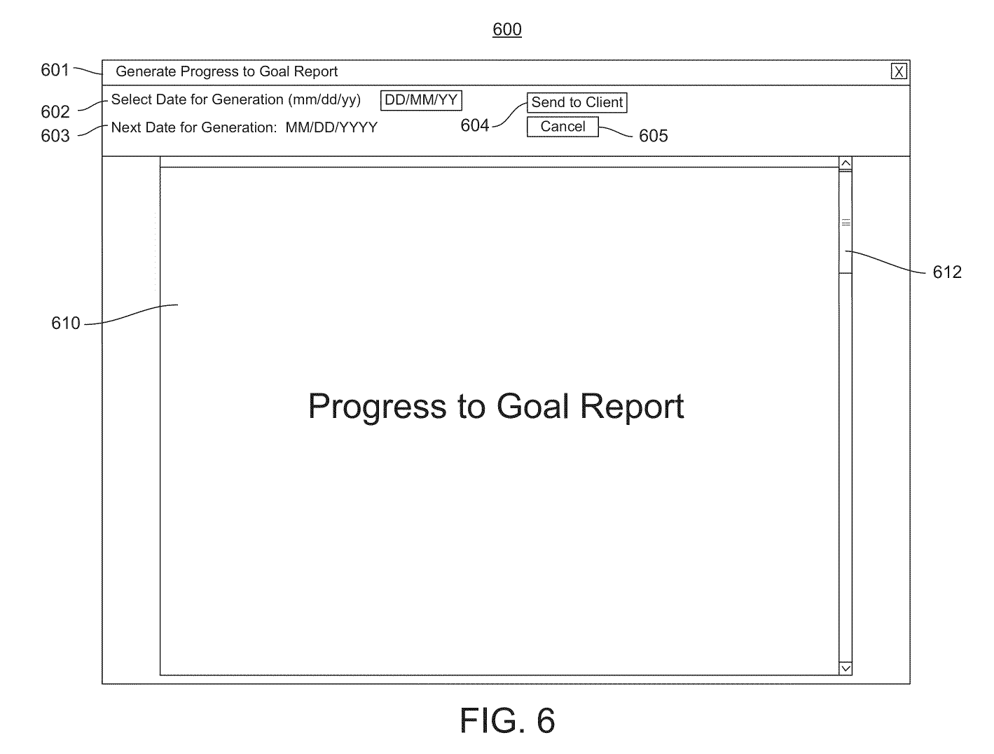

FIG. 6 illustrates an example user interface 600 generating and previewing a progress-to-goal report based on the information included in user interface 400 in accordance with example embodiments. For example, user interface 600 may appear as a display screen overlay in response to a user selecting generate report icon 403. User interface 600 may include, for example, display screen 601 for displaying date field 602 (e.g., “Select date for generation”), date field 603 (e.g., “Next Date for Generation”), and progress-to-goal report preview region 610. A financial advisor may navigate through the progress-to-goal report displayed in region 610 by selecting and manipulating scroll bar 612.

User interface 600 may include send to client icon 604 for transmitting a progress-to-goal report to the client and cancel icon 605 for canceling user interface 600. For example, the transmission of a progress-to-goal report to the client may be initiated, triggered, or scheduled (e.g., for overnight generation, for delivery in accordance with field 602 or 603) when send to client icon 604 is selected. Financial goal management system 204 may then transmit the progress-to-goal report to a computing device such as a printer, facsimile device, computer, wireless device, or other device for paper delivery or electronic delivery (e-delivery) to the client. When cancel icon 605 is selected, the information included in user interface 600 may not be saved, display screen 601 may disappear, and, in some instances, display screen 401 may appear.

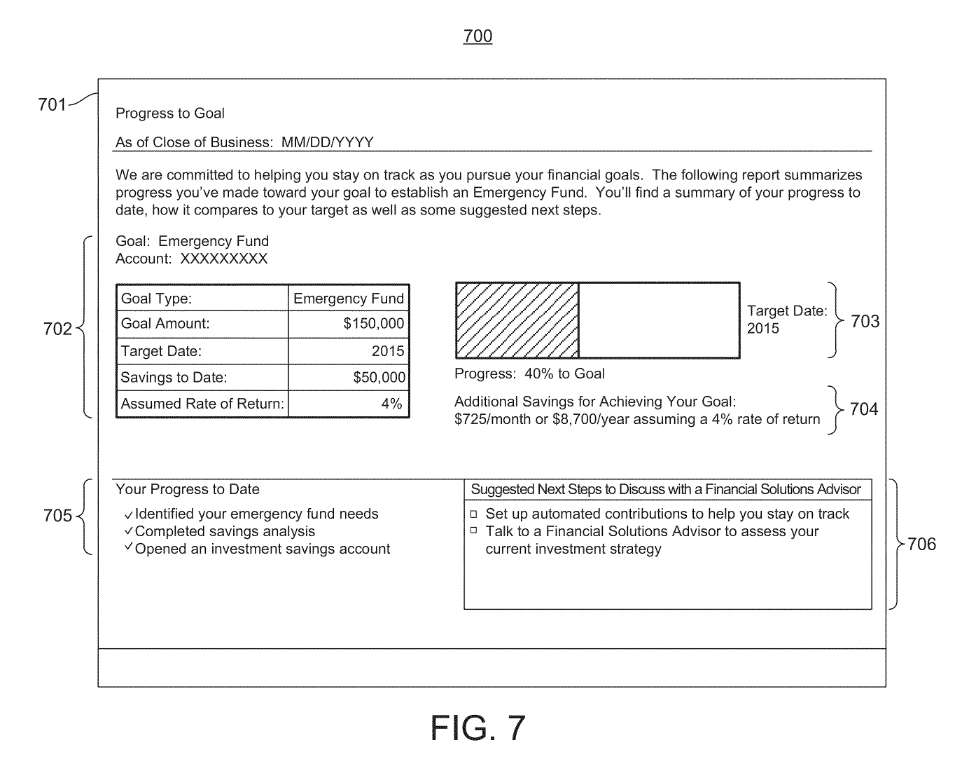

FIG. 7 illustrates an example progress-to-goal report 700 in accordance with example embodiments. Progress-to-goal report 700 may include information generated by financial goal management system 204 based on one or more of information 302, 304, 306, 308, 310, and 312, and/or information included in user interfaces 400 and 600. For example, progress-to-goal report 700 may be generated in response to a user selecting send to client icon 604. Progress-to-goal report 700 may include region 701 for displaying financial goal information, account information, recommended savings information, action step information, progress-to-goal information, and any other information.

Progress-to-goal report 700 may include financial and account information region 702 for displaying financial goal information and account information associated with the financial goal information. For example, region 702 may include a goal type (e.g., “Emergency Fund”), a goal amount (e.g., “$150,000”), a target date (e.g., “2015”), a savings to date (e.g., “$50,000”), and an assumed rate of return (e.g., “4%”).

Progress-to-goal report 700 may include progress-to-goal region 703 for displaying progress-to-goal information. Region 703 may include, for example, the target date, a progress-to-goal bar, and a progress-to-goal value (e.g., “40%”).

Progress-to-goal report 700 may include savings recommendation region 704 for displaying savings recommendation information. Region 704 may include, for example, a recommended savings value (e.g., “$725/month”, “$8,700/year”), and the assumed rate of return used to determine the recommended savings value.

Progress-to-goal report 700 may include action step region 705 for displaying action step information associated with actions steps that have been completed. Region 705 may include, for example, a plurality of action steps (e.g., “Identified your emergency fund needs,” “Completed savings analysis,” “Opened an investment savings account”). In some instances, region 705 may include a check mark positioned adjacent to an action step to indicate that the action step has been completed.

Progress-to-goal report 700 may include action step region 706 for displaying action step information associated with action steps that are in process or have not been started. Region 706 may include, for example, a plurality of action steps (e.g., “Set up automated contributions to help you stay on track,” “Talk to a Financial Solutions Advisor to assess your current investment strategy”). In some instances, region 706 may include an empty box positioned adjacent to an action step to indicate that the action step is still in process or has not been started.

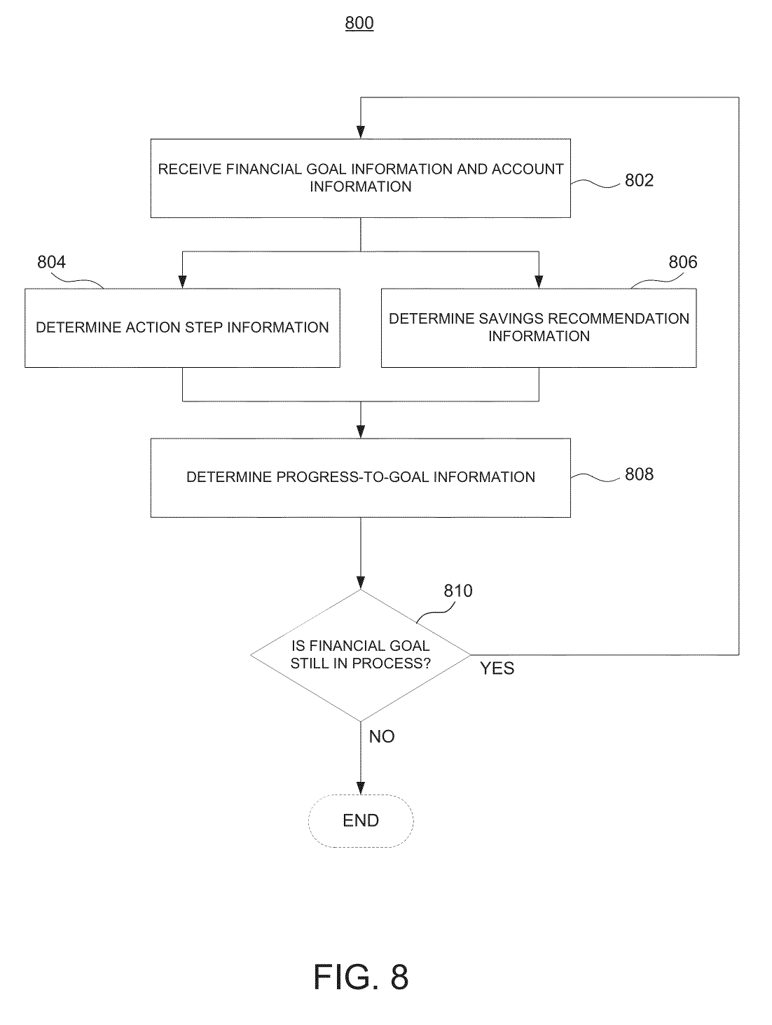

FIG. 8 is a flowchart illustrating example process 800 for providing financial goal management in accordance with example embodiments. The method may be performed by at least one apparatus such as, for example, a computer, server, or other computational device. For example, the method may be implemented by a single apparatus (e.g., computer 101) performing the described operations. The method also may be implemented using two or more devices (e.g., two or more processors, systems, apparatuses, and the like). The order of the steps shown in FIG. 8 is an example. The steps may be arranged in other orders, each function described in each step may be performed one or more times, some steps may be omitted, and/or additional steps may be added. The method may begin at step 802.

At step 802, the financial goal management system (e.g., financial goal management system 204) receives financial goal information (e.g., financial goal information 302) indicative of a financial goal and account information (e.g., account information 308) indicative of an account associated with the financial goal. The financial goal information and the account information may be received from a computing device, such as workstation 201, database 207, remote information source 210, or any other device. In some instances, the financial goal information, the account information, or both may be received in response to input from a user (e.g., a financial advisor) using an input device such as input device 121.

At step 804, the financial goal management system determines action step information indicative of action steps associated with the financial goal. The financial goal management system may determine the action step information based on, for example, the financial goal information and, in some instances, the account information. For example, the financial goal management system may determine action step information 304 based on the financial goal information and the account information.

At step 806, the financial goal management system determines savings recommendation information. The financial goal management system may determine the savings recommendation information based on, for example, the financial goal information and, in some instances, the account information. For example, the financial goal management system may determine savings recommendation information 306 as described with reference to Equations 1-3.

At step 808, the financial goal management system determines progress-to-goal information. The financial goal management system may determine the progress-to-goal information based on, for example, the financial goal information, the account information, the action step information, and the savings recommendation information. For example, the financial goal management system may determine progress-to-goal information 310, which may include a progress-to-goal value as described with reference to Equation 4.

At step 810, the financial goal management system determines whether the financial goal is still in process. For example, the financial goal management system may determine that the financial goal is still in process if the progress-to-goal value is less than 100%. In another example, the financial goal management system may determine that the financial goal is still in process if the action step status of one or more of the action steps is in process or not started. In another example, the financial goal management system may determine that the financial goal is still in process if the goal status field 444 indicates that the financial goal is in process. In some embodiments, the financial goal management system may perform the determination at step 810 at a predetermined time interval, such as every six months. If the financial goal management system determines that the financial goal is still in process, the process may return to step 802. If the financial goal management system determines that the financial goal is not still in process, process 800 may end because the client has either achieved or canceled their financial goal.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disk storage, magnetic cassettes, magnetic tape, magnetic storage and the like. The computer readable instructions may be executed by one or more processors (e.g., multi-core processor or multi-processor systems) to cause a system or apparatus, such as a computing device, to perform various tasks, functions, or both in accordance with some embodiments of the disclosure.

While illustrative systems and methods as described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the disclosure. The description is thus to be regarded as illustrative instead of restrictive on the disclosure.

1. A system, comprising:
a processor; and
a memory storing computer readable instructions that, when executed by the processor, cause the system to:
receive financial goal information indicative of a financial goal, wherein the financial goal information includes a financial goal type, a financial goal value, and a financial goal timeframe;
determine, based on the financial goal information, an account type;
establish an account of the account type by opening a new account of the account type;
link the financial goal information indicative of the financial goal to the new account of the account type;
receive account information associated with the new account of the account type, wherein the account information associated with the new account of the account type includes an account value;
determine, based on the financial goal information and an assumed future rate of return value associated with the new account of the account type, savings recommendation information that includes a recommended savings value for each of a plurality of remaining periods of the financial goal timeframe;
determine, based on the financial goal information, the account information associated with the new account of the account type, and the savings recommendation information that includes the recommended savings value for each of the plurality of remaining periods of the financial goal timeframe, progress-to-goal information for the financial goal;
determine an actual rate of return value associated with the new account of the account type;
determine that the actual rate of return value associated with the new account of the account type is different from the assumed future rate of return value associated with the new account of the account type; and
determine, based on the actual rate of return value associated with the new account of the account type, the financial goal value, the financial goal timeframe, the account value, and the progress-to-goal information for the financial goal, a new recommended savings value for one or more remaining periods of the plurality of remaining periods of the financial goal timeframe, the new recommended savings value being different from the recommended savings value.

2. The system of claim 1, wherein the financial goal information further includes a risk tolerance value, and wherein the computer readable instructions, when executed by the processor, cause the system to:
identify the account type based on the financial goal type, the financial goal value, the financial goal timeframe, and the risk tolerance value.

3-4. (canceled)

5. The system of claim 1, wherein the computer readable instructions, when executed by the processor, cause the system to:
determine action step information indicative of action steps associated with the financial goal based on the financial goal information.

6. The system of claim 1, wherein the computer readable instructions, when executed by the processor, cause the system to:
determine a progress-to-goal percentage value.

7. The system of claim 1, wherein the computer readable instructions, when executed by the processor, cause the system to:
generate a progress-to-goal report based on the progress-to-goal information; and
transmit the progress-to-goal report to a computing device.

8. The system of claim 1, wherein the computer readable instructions, when executed by the processor, cause the system to:
generate an activity record by mapping the financial goal to the account; and
transmit the activity record to a computing device.

9. A non-transitory computer readable storage medium storing computer readable instructions which, when read by a computer, instruct the computer to perform steps, comprising:
receiving financial goal information indicative of a financial goal, wherein the financial goal information includes a financial goal type, a risk tolerance value, a financial goal value, and a financial goal timeframe;
determine, based on the financial goal information, an account type;
establish an account of the account type by opening a new account of the account type;
link the financial goal information indicative of the financial goal to the new account of the account type;
receive account information associated with the new account of the account type, wherein the account information associated with the new account of the account type includes an account value;
determine, based on the financial goal information and an assumed future rate of return value associated with the new account of the account type, savings recommendation information that includes a recommended savings value for each of a plurality of remaining periods of the financial goal timeframe;
determine, based on the financial goal information, the account information associated with the new account of the account type, and the savings recommendation information that includes the recommended savings value for each of the plurality of remaining periods of the financial goal timeframe, progress-to-goal information for the financial goal;
determine an actual rate of return value associated with the new account of the account type;
determine that the actual rate of return value associated with the new account of the account type is different from the assumed future rate of return value associated with the new account of the account type; and
determine, based on the actual rate of return value associated with the new account of the account type, the financial goal value, the financial goal timeframe, the account value, and the progress-to-goal information for the financial goal, a new recommended savings value for one or more remaining periods of the plurality of remaining periods of the financial goal timeframe, the new recommended savings value being different from the recommended savings value.

10-11. (canceled)

12. A method, comprising:
receiving, by a computing device, financial goal information indicative of a financial goal, wherein the financial goal information includes a financial goal type, a financial goal value, and a financial goal timeframe;
determining, by the computing device and based on the financial goal information, an account type;
establishing, by the computing device, an account of the account type by opening a new account of the account type;
linking, by the computing device, the financial goal information indicative of the financial goal to the new account of the account type;
receiving, by the computing device, account information associated with the new account of the account type, wherein the account information associated with the new account of the account type includes an account value;
determining, by the computing device, action step information indicative of action steps associated with the financial goal based on the financial goal information;
determining, by the computing device, and based on the financial goal information and an assumed future rate of return value associated with the new account of the account type, savings recommendation information that includes a recommended savings value for each of a plurality of remaining periods of the financial goal timeframe;
determining, by the computing device, and based on the financial goal information, the account information associated with the new account of the account type, and the savings recommendation information that includes the recommended savings value for each of the plurality of remaining periods of the financial goal timeframe, progress-to-goal information for the financial goal;
determining, by the computing device, an actual rate of return value associated with the new account of the account type;
determining, by the computing device, that the actual rate of return value associated with the new account of the account type is different from the assumed future rate of return value associated with the new account of the account type; and
determining, by the computing device, and based on the actual rate of return value associated with the new account of the account type, the financial goal value, the financial goal timeframe, the account value, and the progress-to-goal information for the financial goal, a new recommended savings value for one or more remaining periods of the plurality of remaining periods of the financial goal timeframe, the new recommended savings value being different from the recommended savings value.

13. The method of claim 12, wherein the financial goal type is one or more of a retirement fund, an education fund, an emergency fund, a large purchase fund, and a general accumulation fund.

14. The method of claim 12, wherein the financial goal information further includes a risk tolerance value, the method further comprising:
identifying, by the computing device, the account type based on the financial goal type, the financial goal value, the financial goal timeframe, and the risk tolerance value.

15-17. (canceled)

18. The method of claim 12, wherein determining the progress-to-goal information comprises determining a progress-to-goal percentage value.

19. The method of claim 12, comprising:
generating, by the computing device, a progress-to-goal report based on the progress-to-goal information; and
transmitting, by the computing device, the progress-to-goal report to a different computing device.

20. The method of claim 12, comprising:
generating, by the computing device, an activity record by mapping the financial goal to the account; and
transmitting, by the computing device, the activity record to a different computing device.
